(19) United States
(12) Patent Application Publication
(10) Pub. No.: US 2008/0107899 A1
(43) Pub. Date: May 8, 2008

(54) Metallized multi-layer films, methods of manufacture and articles made therefrom

(76) Inventor: Pang-Chia Lu, Pittsford, NY (US)

Correspondence Address: ExxonMobil Chemical Company;Law Technology, P.O. Box 2149, Baytown, TX, 77522-2149, US

(21) Appl. No.: 11/593,764

(22) Filed: Nov. 7, 2006

(51) Int. Cl. B32B 15/08; B32B 7/02; B32B 37/00

(52) U.S. Cl. 428/341; 428/461; 156/82

(57) ABSTRACT

Multi-layer films particularly suited for packaging applications, including a core layer, a metallizable layer located on a side of the core layer, the metallizable layer comprising polyethylene and a cyclic olefin copolymer are provided. Optionally, the multi-layer film may have a tie layer located intermediate the core layer and the metallizable layer. Embodiments may have the desirable combination of improved barrier properties and bond strength.

### FIELD OF THE INVENTION

This invention relates generally to metallized, multi-layer films. More specifically, this invention relates to metallized multi-layer films with improved barrier properties and improved bond strength.

### BACKGROUND OF THE INVENTION

In the packaging of certain types of foods including potato chips, snack foods, and the like, there is a high demand for packaging with high gas barrier and high water vapor barrier characteristics and also high durability. Multi-layer polymeric films, particularly polypropylene films, are commonly employed in such packaging applications due to their superior physical properties such as stiffness, moisture barrier characteristics and others. Despite these highly desirable properties, unmodified polypropylene films often lack sufficient gas barrier properties needed for many applications.

Metallic films, such as aluminum foil, are well known in the art for packaging applications. Such metallic films may have both desirable gas barrier and moisture barrier properties, but typically are high in cost. Further, metallic films may lack the mechanical properties needed for many packaging applications.

To improve both gas barrier and moisture barrier properties, multi-layer films have been developed that offer the advantages of both polymeric films and metallic films. Such multi-layer films may typically comprise a polymeric core layer in combination with one or more other polymeric layers or metallized layers. For example, metallized, high barrier films may typically have a polypropylene core layer, a metallized layer and a sealant layer. Most commonly, the metallized layer comprises an ethylene-propylene (EP) or propylene-butylene (PB) polymer which is metallized on one surface thereof by vacuum deposition of a metal (e.g., aluminum), or another metallization process. However, EP and PB polymers are semi-crystalline and lack suitable metal adhesion properties needed for many packaging applications.

Metallized multi-layer films comprising high density polyethylene in the metallized layer provide good metal adhesion, but exhibit weak gas barrier properties.

Films comprising cyclic olefin copolymer (“COC”) resins are known to possess temperature resistance, low curl, low elongation at break under elevated temperatures and other properties that are particularly suited to packaging applications. COCs are also known to be incompatible with polypropylene, and as such are frequently used as cavitating agents in white opaque polypropylene films. However, COCs are compatible with ethylene-based polymers and provide excellent metal adhesion to the film surface.

Low density polyethylene (LDPE) resins, including linear low density polyethylene (LLDPE) resins, are compatible with COCs and promote improved inter-layer adhesion in the film structure.

Some metallized multi-layer films are laminated to other substrates, including various types of films, to protect the metallized surface. However, metal adhesion between the metallized surface and the laminated layer may be weak, resulting in low bond strength. Low bond strength may cause failure of the packaging structure, including peeling, at the interface between the metallized surface and the polymer(s) of laminated layer. Metal layer adhesion of a laminated film is critical to maintaining the structural integrity of the film as well as protecting the metallized surface from damage by the mechanical forces during package processing.

U.S. Publication No. 2006-0046006 to Bastion et al. discloses a flexible multilayer polymer film comprising an unoriented, flexible base polymer layer, a flexible cyclic olefin copolymer layer adhered to the base polymer layer and comprising a cyclic olefin copolymer, and a vapor deposited barrier layer (e.g., metallized layer) on an exposed surface of the flexible cyclic olefin copolymer layer comprising at least one barrier coating. Bastion et al do not disclose the advantage of a biaxially oriented film of the current invention.

U.S. Publication No. 2005-0170161 to Ramchandra et al. discloses a multi-layer pharmaceutical and food packaging film consisting of a core layer comprising polyvinyl chloride and a metallized layer. The film may alternatively include a tie layer which may include a cyclic olefin copolymer. Ramchandra et al do not disclose the use of a blend of polyethylene and cyclic olefin copolymer in a metallized layer of a multi-layer film.

U.S. Publication No. 2005-0142372 to Su et al. discloses a biaxially oriented multilayer film having a thermoplastic core layer comprising an alpha-olefin/polypropylene containing copolymer and a skin layer containing a styrene-butadiene copolymer or a cyclic olefin copolymer. Su et al do not disclose the use of polyethylene and cyclic olefin copolymer in a metallized layer of a multi-layer film.

U.S. Pat. No. 6,017,616 to Kochem et al. (Ticona GmbH and Mutsui) discloses a multi-layer film having cyclic olefin polymers with differing glass transition temperatures in more than one layer. Kochem et al do not teach the combination of polyethylene and cyclic olefin copolymer in a metallized layer.

U.S. Pat. No. 5,861,208 to Schreck (Hoechst Aktiengesellschaft) discloses an opaque, oriented, sealable multilayer film with a core layer of polypropylene and a voided top layer which preferably contains cyclic olefin copolymers as a cavitating agent. Schreck does not disclose the use of a polyethylene and cyclic olefin copolymer blend in a metallized layer.

U.S. Pat. No. 5,866,246 and U.S. Pat. No. 6,124,029, both to Schreck et al. (Ticona GmbH) disclose an oriented thermoplastic film comprising at least one voided layer comprised of various thermoplastic elastomers and cavitating agents. Schreck et al do not disclose the use of a polyethylene and cyclic olefin copolymer blend in a metallized layer.

U.S. Pat. No. 5,693,414 to Peiffer et al. (Hoechst Aktiengesellschaft) discloses an oriented, multilayer film having a polypropylene core layer and a top layer, wherein either layer may comprise a minor amount of an amorphous polymer, such as cyclic olefin copolymer, as a cavitating agent. Peiffer et al do not teach the use of a polyethylene and cyclic olefin copolymer blend in a metallized layer.

None of the films described above combine high gas barrier and high moisture barrier characteristics with improved bond strength for some of today's challenging packaging operations. Therefore, opportunities exist for metallized polymeric films having superior barrier properties and bond strength for applications such as potato chips bags and snack packaging. The present invention meets these and other needs.

### SUMMARY OF THE INVENTION

The present invention generally relates to a metallized multi-layer film comprising a core layer; a metallizable layer located on a side of the core layer, the metallizable layer comprising from about 2 wt % to about 50 wt % polyethylene and from about 98 wt % to about 50 wt % cyclic olefin copolymer, the outermost surface of the metallizable layer having been metallized with at least one metal selected from the group consisting of aluminum, gold, silver, chromium, tin, copper and combinations thereof; wherein the metallized multi-layer film is biaxially oriented prior to metallization.

In another embodiment, the invention generally relates to a metallized multi-layer film comprising a core layer; a metallizable layer located on a side of the core layer, the metallizable layer comprising from about 2 wt % to about 50 wt % polyethylene and from about 98 wt % to about 50 wt % cyclic olefin copolymer, the outermost surface of the metallizable layer having been metallized with at least one metal selected from the group consisting of aluminum, gold, silver, chromium, tin, copper and combinations thereof; a tie layer located intermediate the core layer and the metallizable layer; and a seal layer located on a side of the core layer opposite the metallizable layer; wherein the metallized multi-layer film is biaxially oriented prior to metallization.

Another embodiment of this invention generally relates to a method of producing a metallized multi-layer film comprising the steps of forming a multi-layer film, wherein the film comprises a core layer and a metallizable layer located on a side of the core layer, the metallizable layer comprising from about 2 wt % to about 50 wt % polyethylene and from about 98 wt % to about 50 wt % cyclic olefin copolymer; biaxially orienting the multi-layer film, treating the outermost surface of the metallizable layer with at least one of flame, plasma, corona discharge or polarized flame; and metallizing the outermost surface of the metallizable layer with at least one metal selected from the group consisting of aluminum, gold, silver, chromium, tin, copper and combinations thereof.

In yet another embodiment, the invention generally relates to a package comprising a metallized, biaxially oriented, multi-layer film comprising a core layer and a metallizable layer located on a side of the core layer, the metallizable layer comprising from about 2 wt % to about 50 wt % polyethylene and from about 98 wt % to about 50 wt % cyclic olefin copolymer, the outermost surface of the metallizable layer having been metallized with at least one metal selected from the group consisting of aluminum, gold, silver, chromium, tin, copper and combinations thereof.

The invention also encompasses finished packages, pouches, sealed bags and other articles embodying the film structures above.

### DETAILED DESCRIPTION OF THE INVENTION

Various specific embodiments, versions and examples of the invention will now be described, including definitions that are adopted herein for purposes of understanding the claimed invention. While the following detailed description gives specific preferred embodiments, those skilled in the art will appreciate that these embodiments are exemplary only, and that the invention can be practiced in other ways. For purposes of determining infringement, the scope of the invention will refer to the appended claims and elements or limitations that are equivalent to those that are recited. Any reference to the “invention” may refer to one or more, but not necessarily all, of the embodiments defined by the claims.

As used herein, “polymer” may be used to refer to homopolymers, copolymers, interpolymers, terpolymers, etc. Likewise, a “copolymer” may refer to a polymer comprising two monomers or to a polymer comprising three or more monomers.

As used herein, “intermediate” is defined as the position of one layer of a multi-layer film wherein said layer lies between two other identified layers. In some embodiments, the intermediate layer may be in direct contact with either or both of the two identified layers. In other embodiments, additional layers may also be present between the intermediate layer and either or both of the two identified layers.

As used herein, “substantially free” is defined to mean that the referenced film layer is largely, but not necessarily wholly, absent a particular component. In some embodiments, small amounts of the component may be present within the referenced layer as a result of standard manufacturing methods (e.g., recycling of edge trim) or migration through the polymer layers over time.

Films according to this invention comprise an arrangement of polymeric layers that contribute individually and collectively to improving gas barrier properties and moisture barrier properties while providing excellent bond strength upon lamination to another substrate.

In the multi-layer films of this invention, a cyclic olefin copolymer/polyethylene blend is incorporated into a metallizable layer to facilitate the advantages stated above.

In a preferred embodiment, this invention relates to a metallized multi-layer polymeric film having improved gas barrier and moisture barrier properties and excellent bond strength wherein the film comprises a core layer, a metallizable layer located on a side of the core layer, the metallizable layer comprising from about 2 wt % to about 50 wt % polyethylene and from about 98 wt % to about 50 wt % cyclic olefin copolymer, the outermost surface of the metallizable layer having been metallized with at least one metal selected from the group consisting of aluminum, gold, silver, chromium, tin, copper and combinations thereof, wherein the metallized multi-layer film is biaxially oriented prior to metallization.

### Core Layer

As is known to those skilled in the art, the core layer of a multi-layered film is most commonly the thickest layer and provides the foundation of the multi-layer structure. The core layer of the multi-layer film according to the present invention comprises a film-forming polyolefin, such as, for example, propylene homopolymer, high density polyethylene (HDPE), high crystalline polypropylene (HCPP), ethylene-propylene (EP) copolymer, ethylene-propylene-butylene (EPB) terpolymer or combinations thereof. In a preferred embodiment, the core layer is a polypropylene homopolymer. An example of a suitable polypropylene homopolymer is PP-4612 or PP-4712 (commercially available from ExxonMobil Chemical Company of Baytown, Tex.). Another suitable polypropylene homopolymer is PP-3371 (commercially available from Total Petrochemicals USA of Houston, Tex.).

As is well known in the art, cavitating agents may also be present in the core layer. Generally, cavitating agents may be present in an amount ranging from about 2 wt % to about 30 wt %, preferably from about 5 wt % to about 15 wt %. Cavitating agents may include any suitable organic or inorganic particulate material that is incompatible with the polymer material(s) of the core layer so that, upon stretching of the film during orientation, voids form around some or all of the cavitating agent particles, thereby creating an opaque material. For example, the cavitating agent(s) may be any of those described in U.S. Pat. Nos. 4,377,616, 4,632,869 and 5,691,043, the entire disclosures of which are incorporated herein by reference. Specific examples of suitable cavitating agents are cyclic olefin polymers and copolymers, polybutylene terephthalate (PBT), nylon, solid glass spheres, hollow glass spheres, metals beads or spheres, ceramic spheres, calcium carbonate, talc, chalk and combinations thereof. The average diameter of the cavitating particles typically may be from about 0.1 μm to 10 μm. Cavitation may also be introduced by beta-cavitation, which includes creating beta-form crystals of polypropylene and converting at least some of the beta-form crystals to alpha-form crystals upon stretching, thereby creating a small void near each alpha-crystal. Preferred beta-cavitated embodiments of the core layer may also comprise a beta-crystalline nucleating agent. Substantially any beta-crystalline nucleating agent (“beta nucleating agent” or “beta nucleator”) may be used.

The addition of ethylene vinyl alcohol (“EVOH”) into the core layer of polymeric film structures to improve oxygen barrier properties is commonly known in the art. The core layer of the present invention is substantially free from EVOH. The use of EVOH in the core layer of the present invention could adversely affect the improved barrier properties of the metallized film. As evidenced in the examples, below, the films of this invention provide barrier properties that are superior to films incorporating EVOH in the core layer, as found in the prior art.

The core layer preferably has a thickness in the range of from about 8 μm to 50 μm, more preferably from about 10 μm to 20 μm.

### Metallizable Layer

The metallizable layer is located on a side of the core layer. In some embodiments of this invention, the metallizable layer is contiguous to the core layer. In other embodiments, one or more other layers may be intermediate the core layer and the metallizable layer. The metallizable layer of the present invention comprises at least one polyethylene resin selected from the group consisting of low density polyethylene (LDPE), linear low density polyethylene (LLDPE), very low density polyethylene (VLDPE), medium density polyethylene (MDPE), high density polyethylene (HDPE) and combinations thereof. The polyethylene of the metallizable layer promotes improved inter-layer adhesion between the metallizable layer and the core layer or other intermediate layer.

Suitable low density polyethylenes for use in this invention are LD-105.30 or LL-3002 (commercially available from ExxonMobil Chemical Company of Baytown, Tex.); LLDPEs include Exceed-1018 (commercially available from ExxonMobil Chemical Company of Baytown, Tex.); possible VLDPEs include Affinity EG-8100 (commercially available from The Dow Chemical Company of Midland, Mich.). In preferred embodiments of this invention, the polyethylene has a density in the range of from about 0.88 g/cm³ to about 0.96 g/cm³, more preferably from about 0.90 g/cm³ to about 0.94 g/cm³

The amount of polyethylene in the metallizable layer preferably ranges from about 2 wt % to about 90 wt %, more preferably from about 2 wt % to about 50 wt % and even more preferably from about 10 wt % to about 40 wt %, based on the total weight of the metallizable layer.

The metallizable layer of the present invention further comprises a cyclic olefin copolymer. Cyclic olefin copolymers useful for inclusion in the metallizable layer of the present invention are random copolymers comprising a cyclic olefin monomer, such as norbornene, and ethylene. In preferred embodiments of this invention, the amount of cyclic olefin monomer present in the cyclic olefin copolymer ranges from about 30 wt % to about 60 wt %. Suitable cyclic olefin copolymers for use in this invention are Topas-9506 and Topas 8007F-400 (commercially available from Topas Advanced Polymers GmbH of Germany, formerly Ticona GmbH). The amount of cyclic olefin copolymer in the metallizable layer may range from about 98 wt % to about 10 wt %. Preferably the amount of cyclic olefin copolymer ranges from about 98 wt % to about 50 wt %, and more preferably ranges from about 80 wt % to about 50 wt %, based on the total weight of the metallizable layer. In preferred embodiments, the cyclic olefin copolymer has a glass transition temperature ranging from about 60° C. to about 170° C.

The cyclic olefin copolymers of the metallizable layer impart improved metal adhesion properties to the surface of the layer. When evenly distributed on the surface of the metallizable layer, the cyclic olefin copolymer provides nucleating or metal deposition initiation sites to which the aluminum vapor readily adheres under vacuum metallization and other similar conditions of metallization.

Before applying the metal to the metallizable layer, the outer surface of the film may be treated to increase its surface energy. This treatment can be accomplished by employing known techniques such as flame treatment, plasma treatment, polarized flame, corona discharge, film chlorination, e.g., exposure of the film surface to gaseous chlorine, treatment with oxidizing agents such as chromic acid, hot air or steam treatment, flame treatment and the like. Although any of these techniques is effectively employed to pre-treat the film surface, a frequently preferred method is corona discharge, a treatment method that includes exposing the film surface to a high voltage corona discharge while passing the film between a pair of spaced electrodes. After treatment of the film surface, the metal is then applied thereto.

A dual treatment may also be employed to increase the surface energy of the outer surface of the film. In a dual treatment process, the outer surface of the film is treated by any of the methods discussed above immediately following orientation of the film. Subsequent to the first treatment, the film is subjected to plasma treatment just prior to metallization.

The outer surface of the metallizable layer is preferably metallized using conventional methods, such as vacuum deposition of a metal layer such as aluminum, gold, silver, chromium, tin, copper or mixtures thereof.

Following metallization, the metallized film exhibits excellent oxygen transmission rate (OTR) and water vapor transmission rate (WVTR) characteristics. For example, a metallized film according to the present invention may exhibit an OTR of less than 110 cc/m²/24 hours and a WVTR less than 0.8 g/m²/24 hours. Additionally, in preferred embodiments, the metallized film has an optical density greater than 2.0. These improved physical properties make the film of the present invention ideally suited for packaging food products.

The metallizable layer preferably has a thickness in the range from about 0.1 μm to about 5 μm, more preferably from about 0.2 μm to about 1.5 μm.

### Tie Layer

As is known to those skilled in the art, the tie layer of a multi-layer film is typically used to connect two other partially or fully incompatible layers of the multi-layer film structure, e.g., a core layer and a metallizable layer, and is positioned intermediate and in direct contact with these other layers.

In some embodiments of this invention, the film described herein may be a 3-layer metallized multi-layer film, including a core layer and a metallizable layer, as described above, and a tie layer located intermediate the core layer and the metallizable layer. The tie layer of the present invention preferably comprises at least one polymer selected from the group consisting of polyethylene resin, polypropylene resin, ethylene-propylene copolymer, propylene-butylene copolymer, ethylene-propylene-butylene terpolymer and combinations thereof.

In some embodiments the tie layer may include cavitating agents in an amount ranging from about 2 wt % to about 20 wt % based on the total weight of the tie layer. Examples of suitable cavitating agents are cyclic olefin polymers and copolymers, polybutylene terephthalate, nylon, solid glass spheres, metal beads for spheres, ceramic spheres, calcium carbonate, talc, chalk combinations thereof.

The tie layer preferably has a thickness in the range from about 0.1 μm to about 10 μm, more preferably from about 0.2 μm to about 5 μm.

### Seal Layer

In some embodiments of this invention, a metallized multi-layer film comprises a seal layer located on a side of the core layer opposite the metallizable layer. The seal layer includes a polymer that is suitable for heat-sealing or bonding to itself when crimped between heated crimp-sealer jaws. In some preferred embodiments, the seal layer comprises at least one polymer selected from the group consisting of propylene copolymers, polyethylene, ethylene copolymers, ethylene-propylene random copolymers, butylene copolymers, propylene-butylene random copolymers, ethylene-propylene-butylene terpolymers, polypropylene plastomers, polyethylene plastomers, C₅-C₂₀ alpha olefins and combinations thereof. PB random copolymers suitable for use in this invention are Borealis TD210BF (commercially available from Borealis A/S of Denmark) and BP KS 399 (commercially available from British Petroleum of Great Britain). Suitable EPB terpolymers for use in this invention are Adsyl 5C39F and Adsyl 7384SCP (commercially available from Basell Polyolefins of The Netherlands) and Chisso 7701 and Chisso 7794 (commercially available from Japan Polypropylene Corporation of Japan).

The seal layer preferably has a thickness in the range of from about 0.1 μm to 3 μm.

### Additives

Additives that may be present in any one or more layers of the multi-layer films of this invention, include, but are not limited to opacifying agents, pigments, colorants, cavitating agents, slip agents, antioxidants, anti-fog agents, anti-static agents, anti-block agents, fillers, moisture barrier additives, gas barrier additives, hydrocarbon resins and combinations thereof. Such additives may be used in effective amounts, which vary depending upon the property required.

Examples of suitable opacifying agents, pigments or colorants are iron oxide, carbon black, aluminum, titanium dioxide (TiO₂), calcium carbonate (CaCO₃), polybutylene terephthalate (PBT), talc, beta nucleating agents, and combinations thereof.

Cavitating or void-initiating additives may include any suitable organic or inorganic material that is incompatible with the polymer material(s) of the layer(s) to which it is added, at the temperature of biaxial orientation, in order to create an opaque film. Examples of suitable void-initiating particles are PBT, nylon, solid or hollow pre-formed glass spheres, metal beads or spheres, ceramic spheres, calcium carbonate, talc, chalk, or combinations thereof. Cavitation may also be introduced by beta-cavitation, which includes creating beta-form crystals of polypropylene and converting at least some of the beta-crystals to alpha-form polypropylene crystals and creating a small void remaining after the conversion. Preferred beta-cavitated embodiments of the core layer may also comprise a beta-crystalline nucleating agent. Substantially any beta-crystalline nucleating agent (“beta nucleating agent” or “beta nucleator”) may be used. The average diameter of the void-initiating particles typically may be from about 0.1 to 10 μm.

Slip agents may include higher aliphatic acid amides, higher aliphatic acid esters, waxes, silicone oils, and metal soaps. Such slip agents may be used in amounts ranging from 0.1 wt % to 2 wt % based on the total weight of the layer to which it is added. An example of a slip additive that may be useful for this invention is erucamide.

Non-migratory slip agents, used in one or more skin layers of the multi-layer films of this invention, may include polymethyl methacrylate (PMMA). The non-migratory slip agent may have a mean particle size in the range of from about 0.5 μm to 8 μm, or 1 μm to 5 μm, or 2 μm to 4 μm, depending upon layer thickness and desired slip properties. Alternatively, the size of the particles in the non-migratory slip agent, such as PMMA, may be greater than 20% of the thickness of the skin layer containing the slip agent, or greater than 40% of the thickness of the skin layer, or greater than 50% of the thickness of the skin layer. The size of the particles of such non-migratory slip agent may also be at least 10% greater than the thickness of the skin layer, or at least 20% greater than the thickness of the skin layer, or at least 40% greater than the thickness of the skin layer. Generally spherical, particulate non-migratory slip agents are contemplated, including PMMA resins, such as EPOSTAR™ (commercially available from Nippon Shokubai Co., Ltd. of Japan). Other commercial sources of suitable materials are also known to exist. Non-migratory means that these particulates do not generally change location throughout the layers of the film in the manner of the migratory slip agents. A conventional polydialkyl siloxane, such as silicone oil or gum additive having a viscosity of 10,000 to 2,000,000 centistokes is also contemplated.

Suitable anti-oxidants may include phenolic anti-oxidants, such as IRGANOX® 1010 (commercially available from Ciba-Geigy Company of Switzerland). Such an anti-oxidant is generally used in amounts ranging from 0.1 wt % to 2 wt %, based on the total weight of the layer(s) to which it is added.

Anti-static agents may include alkali metal sulfonates, polyether-modified polydiorganosiloxanes, polyalkylphenylsiloxanes, and tertiary amines. Such anti-static agents may be used in amounts ranging from about 0.05 wt % to 3 wt %, based upon the total weight of the layer(s).

Examples of suitable anti-blocking agents may include silica-based products such as SYLOBLOC® 44 (commercially available from Grace Davison Products of Colombia, Md.), PMMA particles such as EPOSTAR™ (commercially available from Nippon Shokubai Co., Ltd. of Japan), or polysiloxanes such as TOSPEARL™ (commercially available from GE Bayer Silicones of Wilton, Conn.). Such an anti-blocking agent comprises an effective amount up to about 3000 ppm of the weight of the layer(s) to which it is added.

Fillers useful in this invention may include finely divided inorganic solid materials such as silica, fumed silica, diatomaceous earth, calcium carbonate, calcium silicate, aluminum silicate, kaolin, talc, bentonite, clay and pulp.

Suitable moisture and gas barrier additives may include effective amounts of low-molecular weight resins, hydrocarbon resins, particularly petroleum resins, styrene resins, cyclopentadiene resins, and terpene resins.

Hydrocarbon resins that may be used in one or more layers of the present invention include, but are not limited to, petroleum resins, terpene resins, styrene resins and cyclopentadiene resins. In some embodiments, the hydrocarbon resin may be selected from the group consisting aliphatic hydrocarbon resins, hydrogenated aliphatic hydrocarbon resins, aliphatic/aromatic hydrocarbon resins, hydrogenated aliphatic aromatic hydrocarbon resins, cycloaliphatic hydrocarbon resins, hydrogenated cycloalphatic resins, cycloaliphatic/aromatic hydrocarbon resins, hydrogenated cycloalphatic/aromatic hydrocarbon resins, hydrogenated aromatic hydrocarbon resins, polyterpene resins, terpene-phenol resins, rosins and rosin esters, hydrogenated rosins and rosin esters, and combination thereof.

### Film Orientation

The process of orientation is employed to impart desirable properties to films, including increased strength and modulus. Biaxial orientation also improves the moisture barrier properties of the film as a result of increased crystallinity of the polymer(s) imparted by the orientation process. Subsequently, biaxially oriented films exhibit greater resistance to flexing or folding forces. Such resistance makes biaxially oriented films more suitable for metallization than uniaxially oriented or unoriented films.

The embodiments of this invention include biaxial orientation of the multi-layer films. Orientation in the direction of extrusion is known as machine direction (MD) orientation. Orientation perpendicular to the direction of extrusion is known as transverse direction (TD) orientation. Orientation may be accomplished by stretching or pulling a film first in the MD followed by TD orientation. Blown films or cast films may also be oriented by a tenter-frame orientation subsequent to the film extrusion process, again in one or both directions. Orientation may be sequential or simultaneous, depending upon the desired film features. A preferred machine direction orientation ratio for the current invention ranges from about 3 to about 8. More preferably, the machine direction orientation ratio is about 5. A preferred transverse direction orientation ratio for the current invention ranges from about 3 to about 10. More preferably, the machine direction orientation ratio is about 8. Conventional commercial orientation processes are BOPP tenter process, blown film and LISIM technology.

Typically, the films of the present invention are oriented prior to metallization. The resulting oriented film exhibits excellent tensile strength characteristics. For example, an oriented film according to the present invention may exhibit an ultimate tensile strength of at least 100 N/mm² in the machine direction and preferably at least 200 N/mm² in the transverse direction as determined according to ASTM D-882.

### Lamination

In the packaging industry it is common to laminate a film to at least one substrate for use in packaging a variety of food products, including potato chips and snack foods. The laminated structure can be formed by extrusion lamination, also known as polymount lamination, or by adhesive lamination of two or more polymer film webs using solvent-based or water-based adhesives. The key in laminating is the creation of a strong bond between the film and the substrate. To assure the formation of strong lamination bonds, the materials of the adhesive, in the case of adhesive lamination, and/or the layers to be laminated must be compatible. The films of the current invention may be laminated to a substrate by extrusion lamination, adhesive lamination or combinations thereof, to create a laminated film. The substrate is preferably located on the outermost surface of the metallizable layer.

In preferred embodiments, the substrate is selected from the group consisting of oriented polypropylene film, polyethylene terephthalate film, nylon film, polyethylene film, paper board, polyolefin film coated with cationic epoxy acrylate or combinations thereof.

Following lamination, the laminated film exhibits both superior bond strength and excellent metal adhesion on the metallized surface. For example, in extrusion lamination at typical process conditions, the laminated film exhibits bond strengths greater than 120 g/cm with 0% metal transfer from the metallized film to the laminated substrate, as measured by an industry standard T-peel test described herein.

Additionally, the laminated film exhibits excellent oxygen transmission rate and water vapor transmission rate characteristics. For example, a laminated film according to the present invention may exhibit an OTR of less than 90 cc/m²/24 hours and a WVTR less than 0.8 g/m²/24 hours.

### INDUSTRIAL APPLICABILITY

Metallized, multi-layer films according to the present invention are useful as substantially stand-alone film webs or they may be coated and/or laminated to other film structures. Metallized, multi-layer films according to the present invention may be prepared by any suitable methods according to the description and claims of this specification, including orienting and preparing the film for intended use such as by coating, printing, slitting or other converting methods. Preferred methods comprise formation of the multi-layer film followed by orientation and metallization, as discussed in this specification.

For some applications, it may be desirable to laminate the multi-layer films of this invention to other polymeric film or paper products for purposes such as package decor including printing. These activities are typically performed by the ultimate end-users or film converters who process films for supply to the ultimate end-users.

In one embodiment, a method of preparing a metallized, multi-layer film according to the present invention comprises at least the steps of forming a multi-layer film, wherein the film comprises:

a core layer; and

a metallizable layer located on a side of the core layer, the metallizable layer comprising from about 2 wt % to about 50 wt % polyethylene and from about 98 wt % to about 50 wt % cyclic olefin copolymer, and

biaxially orienting the multi-layer film, preferably prior to metallization, and metallizing the outermost surface of the metallizable layer with at least one metal selected from the group consisting of aluminum, gold, silver, chromium, tin, copper and combinations thereof.

The method may further comprise the step of treating the outermost surface of the metallizable layer with at least one of flame, plasma, corona discharge or polarized flame prior to metallization.

Additionally, the method may comprise enclosing a product or article within at least a portion of the metallized multi-layer film.

The prepared metallized multi-layer film may be used as a flexible packaging film to package an article or good, such as a food item or other product.

### EXPERIMENTAL

The metallized multi-layer film of the present invention will be further described with reference to the following non-limiting examples.

### Testing Methods

Water vapor transmission rate is measured according to ASTM F-1249.

Oxygen transmission rate is measured according to ASTM D-3985.

Optical density is a measure of the absorption of visual light, and is determined by standard techniques (ANSI/NAPM IT2.19). To calculate optical density, a commercial densitometer may be used, such as a Macbeth model TD 932, Tobias Densitometer model TDX or Macbeth model TD903. The densitometer is set to zero with no film specimen. A film specimen is placed over the aperture plate of the densitometer with the test surface facing upwards. The probe arm is pressed down and the resulting optical density value is recorded.

Density is measured according to density-gradient method ASTM-D-1505 for plastic materials.

Lamination bond strength is measured using an industry standard T-peel test procedure as follows: A laminated film is cut into an approximately 1 in strip. One end of the film is separated into two layers. The end of each of the two separated layers is inserted into the clip jaw of an Instron machine. The clip jaws of the Instron machine move in opposite directions and a measure of the force required to separate, or peel, the layers is obtained. Lamination bond strength is measured in units of g/in.

Ultimate tensile strength is measured according to ASTM D-882.

### EXAMPLES

Eight samples of 4-layer film structures were produced on a pilot line with a cyclic olefin copolymer/polyethylene (COC/PE) blend as the metallizable layer. The structure of the 4-layer sample films was as follows:

Metallizable layer
Tie layer
Core Layer
Sealant Layer

As provided in these examples, the polymers used to produce the sample films are listed below in Table 1.

TABLE 1

| Polymer | Product code | Manufacturer |
|---|---|---|
| COC | 9506C5 | Topas |
| LLDPE (metallocene) | Exceed- | ExxonMobil Chemical Company |
| | 1018CA | |
| LLDPE (Ziegler-Natta) | LL3002.32 | ExxonMobil Chemical Company |
| LDPE | LD105.30 | ExxonMobil Chemical Company |
| HDPE | XM-6030B | Equistar |
| PP Homopolymer | PP-4712 | ExxonMobil Chemical Company |
| PP terpolymer | Chisso 7794 | Japan Polypropylene |

In each sample film, the core layer was ExxonMobil polypropylene homopolymer, PP-4712. After production, the film samples were metallized with vapor deposited aluminum in a vacuum metallizer.

Lamination of the film samples was performed on a Chesnut extrusion laminator with an LDPE extrudate-adhesive. The substrate used in the lamination to the metallized film samples was 0.7 mil LCX film from ExxonMobil Chemical Company designed for use in lamination applications and particularly for lamination to metallized films. LCX film is treated on one side to create a high energy surface and is heat-sealable on the side opposite the treated side. The laminated structure of the sample films was as follows:

LCX Laminated Layer
Adhesive Layer
Metallized Film

As demonstrated in the data of Table 2, the films of the current invention incorporating a COC/LLDPE blend in the metallizable layer, wherein the COC content was 50% or greater, exhibit very low oxygen transmission rates and water vapor transmission rates after metallization and further after lamination which is very desirable in the packaging of potato chips, snack foods and the like.

TABLE 2

| | Metallizable Layer | | | | | | After | | | |
|---|---|---|---|---|---|---|---|---|---|---|
| | | | Z-N | | Tie Layer | | Metallization | | After | |
| Sample | COC | mLLDPE | LLDPE | LDPE | HDPE | PP | OTR | WVTR | Lamination | |
| # | Topas-9506 | Exceed-1018CA | LL3002.32 | LD105.30 | 6030 | 4712 | cc/m2 | g/m2 | OTR | WVTR |
| 1 | 80% | 20% | 0% | 0% | 100% | 0% | 13 | 0.1 | 9 | 0.1 |
| 2 | 50% | 50% | 0% | 0% | 100% | 0% | 27 | 0.1 | 12 | 0.1 |
| 3 | 20% | 80% | 0% | 0% | 100% | 0% | 47 | 0.6 | 38 | 0.3 |
| 4 | 80% | 0% | 20% | 0% | 100% | | 8 | 0.1 | 5 | 0.1 |
| 5 | 20% | | 80% | | 100% | | 70 | 0.3 | 60 | 0.15 |
| 6 | 20% | | 80% | | 50% | 50% | 90 | 0.4 | 75 | 0.4 |
| 7 | 20% | | | 80% | 50% | 50% | 20 | 0.1 | 33 | 0.1 |

| | | | | | |
|---|---|---|---|---|---|
| 8 | 100% HDPE | 46 | 0.3 | 48 | 0.15 |

Table 3, below, provides data evidencing the acceptable initial bond strength of the films of this invention following lamination. The laminated structures were aged for one week and bond strength was tested again. The data again reveals acceptable bond strengths for the films of this invention. Examples 1 and 4 through 7 indicate improvements in the bond strengths of many of the films incorporating cyclic olefin copolymer/polyethylene blend in the metallizable layer. Most exceptionally, the film of example 1, with a COC content of 80 wt % and 20 wt % metallocene catalyzed LLDPE in the metallizable layer, demonstrates an extraordinary improvement in bond strength following aging.

TABLE 3

| | | | | | | | | | 1 wk |
|---|---|---|---|---|---|---|---|---|---|
| | Metallizable Layer | | | | | | | initial | aged |
| | | | Z-N | | Tie Layer | | metal | bond | bond |
| Sample | COC | mLLDPE | LLDPE | LDPE | HDPE | PP | pick- | strength | strength |
| # | Topas-9506 | Exceed1018A | LL3002.32 | LD105.30 | 6030 | 4712 | off | g/in | g/in |
| 1 | 80% | 20% | 0% | 0% | 100% | 0% | 0 | 340 | 600 |
| 2 | 50% | 50% | 0% | 0% | 100% | 0% | 0 | 380 | 340 |
| 3 | 20% | 80% | 0% | 0% | 100% | | 0 | 470 | 460 |
| 4 | 80% | 0% | 20% | 0% | 100% | | 0 | 315 | 380 |
| 5 | 20% | | 80% | | 100% | | 1–10% | 440 | 530 |
| 6 | 20% | | 80% | | 50% | 50% | 0 | 260 | 430 |
| 7 | 20% | | | 80% | 50% | 50% | 0 | 390 | 400 |

| | | | | |
|---|---|---|---|---|
| 8 | 100% HDPE | 0 | 390 | 425 |

As we have demonstrated above, the structures of this invention have improved barrier properties and lamination bond strength while maintaining excellent metal adhesion on the metallizable layer.

The present invention is described herein with reference to embodiments of multi-layer films. Those skilled in the art will appreciate that numerous modifications to these embodiments may be made without departing from the scope of our invention. For example, while certain film layers are exemplified as being comprised of specific polymer blends and additives, along with a certain arrangement of layers within the film, other compositions and arrangements are also contemplated. Additionally, while packaging is discussed among the uses for embodiments of our inventive films, other uses, such as labeling and printing, are also contemplated.

To the extent that this description is specific, it is solely for the purpose of illustrating certain embodiments of the invention and should not be taken as limiting the present inventive concepts to these specific embodiments. Therefore, the spirit and scope of the appended claims should not be limited to the description of the embodiments contained herein.

What is claimed is:

1. A metallized multi-layer film, comprising:
(a) a core layer; and
(b) a metallizable layer located on a side of said core layer, said metallizable layer comprising from about 2 wt % to about 50 wt % polyethylene and from about 98 wt % to about 50 wt % cyclic olefin copolymer, the outermost surface of said metallizable layer having been metallized with at least one metal selected from the group consisting of aluminum, gold, silver, chromium, tin, copper and combinations thereof,
wherein said metallized multi-layer film is biaxially oriented prior to metallization.

2. The metallized multi-layer film of claim 1, wherein said film further comprises a tie layer located intermediate said core layer and said metallizable layer.

3. The metallized multi-layer film of claim 1, wherein said core layer comprises at least one polymer selected from the group consisting of propylene homopolymer, high density polyethylene, high crystalline polypropylene, ethylene-propylene copolymer, ethylene-propylene-butylene terpolymer and combinations thereof.

4. The metallized multi-layer film of claim 1, wherein said core layer is substantially free from ethylene vinyl alcohol.

5. The metallized multi-layer film of claim 2, wherein at least one of said core layer and said tie layer further comprises a cavitating agent selected from the group consisting of cyclic olefin polymers and copolymers, polybutylene terephthalate, nylon, solid glass spheres, hollow glass spheres, metal beads or spheres, ceramic spheres, calcium carbonate, talc, chalk and combinations thereof.

6. The metallized multi-layer film of claim 2, wherein at least one of said core layer, said metallizable layer and said tie layer further comprises at least one additive selected from the group consisting of opacifying agents, fillers, anti-block agents, anti-static agents, slip agents, pigments, colorants, antioxidants, anti-fog agents, moisture barrier additives, gas barrier additives, hydrocarbon resins and combinations thereof.

7. The metallized multi-layer film of claim 1, wherein said polyethylene of said metallizable layer is selected from the group consisting of low density polyethylene, linear low density polyethylene, very low density polyethylene, medium density polyethylene, high density polyethylene and combinations thereof.

8. The metallized multi-layer film of claim 1, wherein said polyethylene of said metallizable layer has a density in the range of from about 0.88 g/cm³ to about 0.96 g/cm³.

9. The metallized multi-layer film of claim 1, wherein said polyethylene of said metallizable layer has a density in the range of from about 0.90 g/cm³ to about 0.94 g/cm³.

10. The metallized multi-layer film of claim 1, wherein said cyclic olefin copolymer of said metallizable layer is a random copolymer comprising a cyclic olefin monomer and ethylene.

11. The metallized multi-layer film of claim 10, wherein said cyclic olefin copolymer of said metallizable layer comprises from about 30 wt % to about 60 wt % cyclic olefin monomer.

12. The metallized multi-layer film of claim 1, wherein said cyclic olefin copolymer has a glass transition temperature ranging from about 60° C. to about 170° C.

13. The metallized multi-layer film of claim 1, wherein said film has a machine direction orientation ratio in the range of from about 3 to about 8 and a transverse direction orientation ratio in the range of from about 3 to about 10.

14. The metallized multi-layer film of claim 1, wherein said metallizable layer is treated on the outermost surface with at least one of flame, plasma, corona discharge or polarized flame prior to metallization.

15. The metallized multi-layer film of claim 1, wherein said film has an optical density greater than 2.0.

16. The metallized multi-layer film of claim 1, wherein said film has an oxygen transmission rate less than 110 cc/m²/24 hours.

17. The metallized multi-layer film of claim 1, wherein said film has a water vapor transmission rate less than 0.8 g/m²/24 hours.

18. The metallized multi-layer film of claim 2, wherein said tie layer comprises at least one polymer selected from the group consisting of polyethylene resin, polypropylene resin, ethylene-propylene copolymer, propylene-butylene copolymer, ethylene-propylene-butylene terpolymer, and combinations thereof.

19. The metallized multi-layer film of claim 1, wherein said film further comprises a seal layer located on a side of said core layer opposite said metallizable layer.

20. The metallized multi-layer film of claim 19, wherein said seal layer comprises at least one polymer selected from the group consisting of propylene copolymers, polyethylene, ethylene copolymers, ethylene-propylene (EP) random copolymers, butylene copolymers, propylene-butylene (PB) random copolymers, ethylene-propylene-butylene (EPB) terpolymers, polypropylene plastomers, polyethylene plastomers, C₅-C₂₀ alpha olefins and combinations thereof.

21. The metallized multi-layer film of claim 20, wherein said seal layer further comprises at least one additive selected from the group consisting of opacifying agents, cavitating agents, fillers, anti-block agents, anti-static agents, slip agents, pigments, colorants, antioxidants, anti-fog agents, moisture barrier additives, gas barrier additives, hydrocarbon resins and combinations thereof.

22. The metallized multi-layer film of claim 1, wherein said film is further laminated to a substrate located on the outermost surface of said metallizable layer.

23. The metallized multi-layer film of claim 22, wherein said substrate is selected from the group consisting of oriented polypropylene film, polyethylene terephthalate film, nylon film, polyethylene film, paper board, polyolefin film coated with cationic epoxy acrylate or combinations thereof.

24. The metallized multi-layer film of claim 22, wherein said substrate is applied to the outermost surface of said metallizable layer by at least one of extrusion lamination, adhesive lamination or combinations thereof, to create a laminated film.

25. The metallized multi-layer film of claim 24, wherein said laminated film has a lamination bond strength of greater than 120 g/in.

26. The metallized multi-layer film of claim 24, wherein said laminated film has an oxygen transmission rate less than 90 cc/m²/24 hours.

27. The metallized multi-layer film of claim 24, wherein said laminated film has a water vapor transmission rate less than 0.5 g/m²/24 hours.

28. A metallized multi-layer film, comprising:
(a) a core layer;
(b) a metallizable layer located on a side of said core layer, said metallizable layer comprising from about 2 wt % to about 50 wt % polyethylene and from about 98 wt % to about 50 wt % cyclic olefin copolymer, the outermost surface of said metallizable layer having been metallized with at least one metal selected from the group consisting of aluminum, gold, silver, chromium, tin, copper and combinations thereof;
(c) a tie layer located intermediate said core layer and said metallizable layer; and
(d) a seal layer located on a side of said core layer opposite said metallizable layer,
wherein said metallized multi-layer film is biaxially oriented prior to metallization.

29. A method of producing a metallized multi-layer film comprising the steps of:
(a) forming a multi-layer film, wherein said film comprises,
(i) a core layer; and
(ii) a metallizable layer located on a side of said core layer, said metallizable layer comprising from about 2 wt % to about 50 wt % polyethylene and from about 98 wt % to about 50 wt % cyclic olefin copolymer;
(b) biaxially orienting said multi-layer film, and
(c) treating the outermost surface of said metallizable layer with at least one of flame, plasma, corona discharge or polarized flame;
(d) metallizing the outermost surface of said metallizable layer with at least one metal selected from the group consisting of aluminum, gold, silver, chromium, tin, copper and combinations thereof.

30. The method of claim 29, wherein said film has an optical density greater than 2.0.

31. The method of claim 29, wherein said cyclic olefin copolymer of said metallizable layer is a random copolymer comprising a cyclic olefin monomer and ethylene.

32. The method of claim 29, wherein said cyclic olefin copolymer comprises from about 30 wt % to about 60 wt % cyclic olefin monomer.

33. The method of claim 29, wherein said cyclic olefin copolymer has a glass transition temperature ranging from about 60° C. to about 170° C.

34. The method of claim 29, wherein said film has a machine direction orientation ratio in the range of from about 3 to about 8 and a transverse direction orientation ratio in the range of from about 3 to about 10.

35. The method of claim 29, wherein said film has an oxygen transmission rate less than 110 cc/m²/24 hours.

36. The method of claim 29, wherein said film has a water vapor transmission rate less than 0.8 g/m²/24 hours.

37. The method of claim 29, wherein said film is further laminated to a substrate located on the outermost surface of said metallizable layer.

38. The method of claim 29, wherein said substrate is applied to the outermost surface of said metallizable layer by at least one of extrusion lamination, adhesive lamination or combinations thereof, to create a laminated film.

39. The method of claim 37, wherein said substrate is selected from the group consisting of oriented polypropylene film, polyethylene terephthalate film, nylon film, polyethylene film, polyolefin film coated with cationic epoxy acrylate or combinations thereof.

40. The method of claim 38, wherein said laminated film has a lamination bond strength of greater than 120 g/in.

41. The method of claim 38, wherein said laminated film has an oxygen transmission rate less than 90 cc/m²/24 hours.

42. The method of claim 38, wherein said laminated film has a water vapor transmission rate less than 0.5 g/m²/24 hours.

43. A package comprising a metallized multi-layer film comprising:
(a) a core layer; and
(b) a metallizable layer located on a side of said core layer, said metallizable layer comprising from about 2 wt % to about 50 wt % polyethylene and from about 98 wt % to about 50 wt % cyclic olefin copolymer, the outermost surface of said metallizable layer having been metallized with at least one metal selected from the group consisting of aluminum, gold, silver, chromium, tin, copper and combinations thereof,
wherein said metallized multi-layer film is biaxially oriented prior to metallization and wherein said metallized multi-layer film is formed into a package adapted to contain a product.
